(19) United States
(12) Patent Application Publication
(10) Pub. No.: US 2007/0168738 A1
(43) Pub. Date: Jul. 19, 2007

(54) Power-on error detection system and method

(75) Inventor: Chien-Chih Wang, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/396,075

(22) Filed: Mar. 30, 2006

(30) Foreign Application Priority Data
Dec. 12, 2005 (TW) 94143795

(51) Int. Cl. G06F 11/00

(52) U.S. Cl. 714/36

(57) ABSTRACT

A power-on error detection system and method applicable in an electronic device having a motherboard is proposed, wherein the motherboard is provided with a memory for storing a BIOS program and a signal outputting unit. The power-on error detection system and method are used to indicate an operation state of the electronic device while the electronic device reads the BIOS program at power-on and performs a POST (Power-on self-test) process. A first warning signal output command is set in the a segment of the BIOS program. The first warning signal output command drives the signal outputting unit to output a first warning signal after the electronic device is turned on and executes the POST process according to the BIOS program stored in the memory.

### BACKGROUND OF THE INVENTION

1. Field of the Invention

The present invention relates generally to a power-on error detection system and method, and more particularly to a power-on error detection system and method which detect whether components of an electronic device operate normally through a BIOS (Basic Input Output System) program.

2. Description of Related Art

Currently, for an electronic device, there are many kinds of error detection methods, and one of the most common methods is to sound a warning signal in the event that error occurs in an electronic device.

The above method is further improved by Taiwan Patent Publication No. 512275, which proposes a method for detecting and displaying errors of an electronic component. According to this method, after an electronic device is turned on while before the monitor of the electronic device begins to run, if error occurs in any one of components of the electronic device such as a BIOS, a memory or a display card, a LED (light-emitting diode) installed on a case of the electronic device flickers at different frequencies or displays different colors corresponding to different component damages or configuration errors of the electronic device.

However, the above method is only suitable for finished products or electronic devices having an error detection apparatus installed thereon. For a computer motherboard still at a design stage, since port 80 is not disposed on the computer motherboard and there is not any output interface such as a display, in the event that error occurs in the computer motherboard, designers or debugging staff need to take a lot of time to debug. The reason for errors can be poor design of hardware circuits of the motherboard, incorrect configuration of components of the motherboard, incorrect program codes in the BIOS program or the like. Thus, the developing period of an electronic device is increased.

In addition, the present method for checking whether a memory of a motherboard is normal is to test whether program codes of a BIOS program can be loaded into the memory normally. If the program codes can not be loaded into the memory because the memory is damaged or electrical connection between the memory and the corresponding slot is incorrect, the motherboard sounds three continuous beeps, which indicate that error occurs when the program codes of the BIOS program are loaded into the memory. However, even if the program codes of the BIOS program is loaded into the memory successfully and the motherboard does not send out any warning signals, it doesn't indicate that there is no problem in the memory design of the motherboard. It may happens that although the program codes of the BIOS program have been successfully loaded into the memory, such design defects as unstable voltages or unstable pulses of memory socket components of the motherboard can cause problems when the system switches from the memory storing the BIOS program to the memory storing operational parameters, thereby affecting the startup of the electronic device. Since there is no display and assistant error detection apparatus for displaying the error position, it increases debugging difficulty and also increases the developing period of an electronic device.

### SUMMARY OF THE INVENTION

According to the above defects, it is an objective of the present invention to provide a power-on error detection system and method which can help designers or debugging staff to identify the reason for error during the POST process of an electronic device.

It is another objective of the present invention to provide a power-on error detection system and method which can facilitate the debugging process of an electronic device at a design or manufacture process, thereby shortening manufacturing period of the electronic device.

In order to attain the above and other objectives, the present invention discloses a power-on error detection system and method, which is applicable in an electronic device having a motherboard. Therein, the motherboard is provided with a memory for storing a BIOS (Basic Input Output System) program. The power-on error detection system and method of the present invention is used to indicate the operation state of an electronic device while the electronic device reads the BIOS program at power-on and performs a POST (Power-on self-test) process. The power-on error detection system of the present invention includes: a CPU (Central Processing Unit) functioning as a control kernel of the motherboard, wherein, the CPU is electrically connected with the memory of the motherboard such that the CPU can execute the POST process according to the BIOS program stored in the memory at power-on of the electronic device, and the BIOS program comprises a first warning signal output command stored in the first segment of the BIOS program; and a signal outputting unit electrically connected with the CPU, the signal outputting unit being driven to output a first warning signal by the first warning signal output command of the BIOS program while the CPU executes the POST process. The first warning signal indicates that hardware circuits of the motherboard are correct.

In another embodiment, the power-on error detection system according to the present invention further includes a storage unit for storing operational parameters produced during operation of the electronic device, and a second warning signal output command is written to a program segment in the BIOS program used to complete accessing the operational parameters of the storage unit. Therein, if the CPU can complete accessing the operational parameters of the storage unit according to the BIOS program after power-on of the electronic device, the signal outputting unit is driven by the second warning signal output command to output a second warning signal. The second warning signal indicates that configuration of the storage unit is correct.

The power-on error detection method according to the present invention includes: setting a first warning signal output command in a first segment of the BIOS program; and driving the storage unit by the first warning signal output command of the BIOS program to output a first warning signal when the electronic device is turned on and performs the POST process. The first warning signal indicates that hardware circuits of the motherboard are correct.

In another embodiment, the power-on error detection method according to the present invention further includes a storage unit for storing operational parameters produced during operation of the electronic device, and a second warning signal output command is stored in a segment of the BIOS program used to complete accessing the operational parameters of the storage unit, the second warning signal output command driving the signal outputting unit to output a second warning signal if the electronic device successfully accesses the operational parameters of the storage unit according to the BIOS program after the electronic device is turned on and runs a period of time. Thus, designers or debugging staff can timely know that configuration of the storage unit is correct according to the second warning signal.

As described above, a power-on error detection system and method according to the present invention is to write warning signal output commands at specific operational state corresponding to certain I/O interfaces into certain program segments of the BIOS program such that designers or debugging staff can perform power-on test of the electronic device without the need of any additional error detection assistant tools. During the test process, if the tested components can work normally, the BIOS program drives the signal outputting unit to send a warning signal indicating that the components of the electronic device work normally, otherwise, if no warning signals are outputted, designers or debugging staffs can easily know that error occurs in the components. According to the present invention, not only the design and debug processes are facilitated, but the debug speed can also be increased, thereby increasing the product efficiency.

### BRIEF DESCRIPTION OF DRAWINGS

FIG. 1 depicts a schematic block diagram of a basic structure of a power-on error detection system according to the present invention.

FIG. 2 depicts a flow chart of a power-on error detection method according to the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification. The present invention can also be performed or applied by other different embodiments. The details of the specification may be on the basis of different points and applications, and numerous modifications and variations can be devised without departing from the spirit of the present invention.

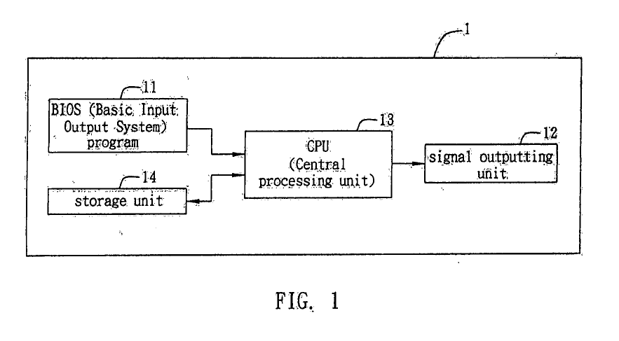

FIG. 1 is a schematic block diagram of a basic structure of a power-on error detection system according to the present invention. In the present embodiment, the power-on error detection system can be applied in an electronic device having a motherboard, wherein the electronic device can be such as a desktop computer, a notebook computer, a server, a PDA (Personal Digital Assistant), a mobile telephone and the like. As shown in FIG. 1, the power-on error detection system 1 at least comprises a BIOS (Basic Input Output System) program 11, a signal outputting unit 12, a CPU (Central Processing Unit) 13 and a storage unit 14. But it should be noted that the motherboard further comprises other components such as a power supply module, south and north bridge chipsets, I/O interfaces and so on. Herein merely components related to the present invention are shown.

The signal outputting unit 12 can be a loudspeaker unit, a display unit (e.g., a LED display or a LCD display) or the like having a warning function. In the present embodiment, the signal outputting unit 12 is a loudspeaker unit, such as a trumpet that is electrically connected with the motherboard of an electronic device and is capable of sending a beep when the electronic device is turned on.

The CPU 13 is a control kernel of the motherboard. Since the CPU 13 is already known by those skilled in the art, function and inner structure of the CPU 13 will not be described in detail hereafter.

The BIOS program 11 is stored in a memory such as a ROM (Read-only memory). The BIOS program 11 comprises a lot of basic control codes of I/O interfaces of an electronic device such as a display and a keyboard. Also, the BIOS program 11 is responsible for a POST (power-on self-test) process at power-on of the electronic device. Since the BIOS program 11 is a conventional technology, detailed description of it is omitted.

The power-on error detection system 1 according to the present invention is used to judge whether the electronic device can access the BIOS program 11 stored in the memory at power-on of the electronic device, if yes, a first warning signal output command stored in the BIOS program 11 drives the signal outputting unit 12 to output a first warning signal. Furthermore, the power-on error detection system 1 of the present invention judges whether the electronic device can access operational parameters temporarily stored in the storage unit 14 such as a CMOS or a DDR during the POST process, if yes, a second warning signal output command stored in the BIOS program 11 drives the signal outputting unit 12 to output a second warning signal.

In the present embodiment, the first warning signal output command is written in the first segment of the BIOS program 11. If the signal outputting unit 12 outputs the first warning signal such as a beep lasting 6 seconds shortly after the power-on of the electronic device, it indicates that the hardware circuits of the motherboard are correct and the CPU 13 can access the BIOS program 11 of the memory, otherwise, if the POST process seems to have been paused and there is no warning signal outputted from the signal outputting units 12 for a long while after the power-on of the electronic device, it indicates that error occurs in the hardware circuits of the motherboard related to the CPU 13, the error preventing the electronic device from executing the POST to the I/O interfaces correctly according to BIOS program.

On the other hand, the second warning signal output command in the present embodiment is written in a segment of the BIOS program 11 used to complete accessing the operational parameters of the storage unit 14. Accordingly, if the signal outputting unit 12 outputs the second warning signal composed of a long beep and two short beeps, for example, shortly after the power-on of the electronic device such as 12 seconds or shortly after the output of the first warning signal, it indicates that there is no problem in configuration of the storage unit 14, e.g., circuit layout on the motherboard for accessing the storage unit 14 is correct and tracks of the storage unit 14 are not damaged; otherwise, if the POST process seems to have been paused and the second warning signal is not outputted from the signal outputting unit 12 a long while after the power-on of the electronic device or after the output of the first warning signal, it indicates that error occurs in the configuration of the storage unit 14, the error preventing the electronic device from correctly executing the POST process to the storage unit 14 according to BIOS program.

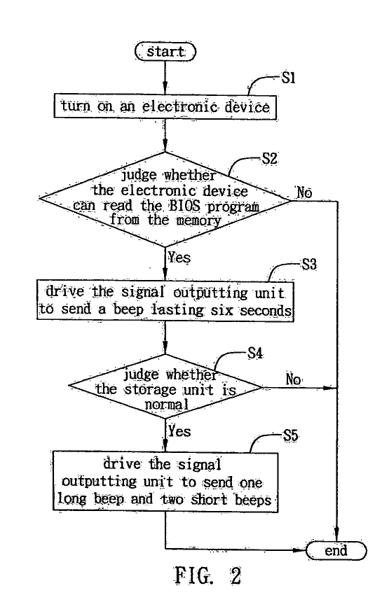

Referring now to FIG. 2, shown is a flow chart of the power-on error detection method according to the present invention. The power-on error detection method of the present invention can be applied in an electronic device having a motherboard. As shown in FIG. 2, first, at step S1, an electronic device is turned on so as to read the BIOS program 11 stored in a memory such as a ROM and execute a POST process. Then, process flow proceeds to step S2.

At step S2, whether or not the BIOS program of the memory can be read by the electronic device for executing the POST process is judged. If the electronic device can read the BIOS program 11 from the memory for executing the POST process, process flow proceeds to step S3; otherwise, process flow is ended. That is, if the POST process seems to have been paused and there is no warning signal outputted from the signal outputting units 12 a long while after the power-on of the electronic device, it indicates that error occurs in the hardware circuits of the motherboard related to the CPU 13, the error preventing the electronic device from executing the POST to the I/O interfaces correctly according to BIOS program 11. Thereby, designers or debugging staff can quickly and readily understand that it is the error of the hardware circuits of the motherboard that leads to the unsuccessful startup of the electronic device.

At step S3, when the electronic device can execute the POST process according to the BIOS program 11 stored in the memory, the signal outputting unit 12 is driven by a first warning signal output command to output a first warning signal which indicates that hardware circuits of the motherboard related to the CPU 13 is normal, wherein, the first warning signal output command is written in the first segment of the BIOS program 11. Then, process flow proceeds to step S4.

At step S4, whether or not the electronic device can finish accessing the storage unit 14 is judged while the electronic device executes the POST process according to the BIOS program 11, that is, whether or not the storage unit 14 is normal is judged. If yes, process flow proceeds to step S5; otherwise, process flow is ended. That is, if the POST process seems to have been paused and there is no second warning signal outputted from the signal outputting unit 12 a long while after the power-on of the electronic device, it indicates that error occurs in the configuration of the storage unit 14, the error preventing the electronic device from executing the POST process to the storage unit 14 correctly according to BIOS program. Thus, designers or debugging staff can quickly and readily understand that it is the error of the configuration of the storage unit that leads to the unsuccessful startup of the electronic device.

At step S5, when the electronic device finishes accessing the storage unit 14, the signal outputting unit 12 is driven by a second warning signal output command to output a second warning signal which indicates that the configuration of the storage unit 14 is normal, wherein, the second warning signal output command is written in a segment of the BIOS program 11 used to complete accessing the storage unit 14. Accordingly, shortly after power-on of the electronic device such as 12 seconds or shortly after the output of the first warning signal, designers or debugging staff can timely know that the configuration of the storage unit 14 is correct according to the second warning signal outputted by the signal outputting unit 12.

In another embodiment of the power-on error detection method according to the present invention, an additional step can be added between step S3 and step S4. According to the present step, when the electronic device begins to read the storage unit 14, if the electrical connection between the storage unit 14 and the corresponding slot is not normal, the signal outputting unit 12 is driven by a third warning signal output command to output a third warning signal, wherein, the third warning signal output command is written in a segment of the BIOS program 11 used to begin reading the storage unit 14. Thus, if there is a poor contact between the storage unit and the corresponding slot, or if configurations of the slot and the storage unit 14 are not matched to each other such as specifications of a DIMM slot and a DDR are not matched to each other, the signal outputting unit 12 is driven to output the third warning signal such as three continuous beeps indicating the electrical connection between the storage unit 14 and the corresponding slot is not correct. Thus, designers or debugging staff can easily and quickly knows that the storage unit 14 is not normal or the circuit layout on the motherboard for accessing the storage unit 14 is not normal.

As described above, the power-on error detection system and method according to the present invention is to write warning signal output commands at specific operational states corresponding to certain I/O interfaces into certain segments of the BIOS program, which allows designers or debugging staff to quickly and easily find reason for errors, especially at the preliminary stage of the motherboard design and manufacture, thereby facilitating the design and debug and increasing the design and debug efficiency.

What described above is to describe preferred embodiments of the present invention as illustrative and not restrictive of the scope of the essential technical content according to the present invention, the essential technical content of the present invention is broadly defined in the appended claim, if the exemplary embodiments or method implemented by any one are completely identical to the following claim or only an equivalent change of the following claim, all that is considered to fall with the scope of the invention.

What is claimed is:

1. A power-on error detection system applicable in an electronic device having a motherboard, wherein the motherboard is provided with a memory for storing a BIOS (Basic Input Output System) program, and wherein the power-on error detection system is for indicating an operation state of the electronic device when the electronic device reads the BIOS program at power-on and performs a POST (Power-on self-test) process, the power-on error detection system comprising:
a CPU (Central Processing Unit) functioning as a control kernel of the motherboard, and electrically connected with the memory of the motherboard, the CPU being configured for executing the POST process according to the BIOS program stored in the memory at power-on of the electronic device, wherein the BIOS program comprises a first warning signal output command stored in a first segment of the BIOS program; and
a signal outputting unit electrically connected with the CPU, the signal outputting unit being driven to output a first warning signal by the first warning signal output command of the BIOS program when the CPU executes the POST process.

2. The system of claim 1, wherein the first warning signal is for indicating that hardware circuits of the motherboard are correct.

3. The system of claim 2, wherein the hardware circuits of the motherboard refer to hardware circuits related to the CPU.

4. The system of claim 1, wherein the motherboard of the electronic device further comprises a storage unit for storing operational parameters produced during operation of the electronic device, and the BIOS program further comprises a second warning signal output command stored in a segment of the BIOS program completing accessing the operational parameters of the storage unit, the second warning signal output command for driving the signal outputting unit to output a second warning signal if the CPU successfully accesses the operational parameters of the storage unit according to the BIOS program after the electronic device is turned on and runs for a period of time.

5. The system of claim 4, wherein the second warning signal is for indicating that configuration of the storage unit is correct.

6. The system of claim 5, wherein the configuration of the storage unit refers to circuit layout on the motherboard for accessing the storage unit.

7. The system of claim 5, wherein the configuration of the storage unit refers to a track state of the storage unit.

8. The system of claim 4, wherein the BIOS program further comprises a third warning signal output command stored in a segment of the BIOS program for beginning reading the parameters in the storage unit, the third warning signal output command for driving the signal outputting unit to output a third warning signal if the CPU cannot read the parameters in the storage unit according to the BIOS program after the electronic device is turned on and runs for a period of time.

9. The system of claim 8, wherein the third warning signal is for indicating that electrical connection between the storage unit and a corresponding slot is incorrect.

10. The system of claim 1, wherein the signal outputting unit is one of a loudspeaker unit and a display unit.

11. A power-on error detection method applicable in an electronic device having a motherboard, wherein the motherboard is provided with a memory for storing a BIOS program and a signal outputting unit, the power-on error detection method for indicating an operation state of the electronic device when the electronic device reads the BIOS program at power-on and performs a POST (Power-on self-test) process, the method comprising the steps of:
setting a first warning signal output command in a first segment of the BIOS program; and
driving the signal outputting unit by the first warning signal output command of the BIOS program to output a first warning signal when the electronic device is turned on and performs the POST process.

12. The method of claim 11, wherein the first warning signal is for indicating that hardware circuits of the motherboard are correct.

13. The method of claim 12, wherein the hardware circuits of the motherboard refer to hardware circuits related to the CPU.

14. The method of claim 11, wherein the motherboard of the electronic device further comprises a storage unit for storing operational parameters produced during operation of the electronic device, and a second warning signal output command is stored in a segment of the BIOS program for completing accessing the operational parameters of the storage unit, the second warning signal output command for driving the signal outputting unit to output a second warning signal if the electronic device successfully accesses the operational parameters of the storage unit according to the BIOS program after the electronic device is turned on and runs for a period of time.

15. The method of claim 14, wherein the second warning signal is for indicating that configuration of the storage unit is correct.

16. The method of claim 15, wherein the configuration of the storage unit refers to circuit layout on the motherboard for accessing the storage unit.

17. The method of claim 15, wherein the configuration of the storage unit refers to a track state of the storage unit.

18. The method of claim 14, wherein the BIOS program further comprises a third warning signal output command stored in a segment of the BIOS program beginning reading the parameters in the storage unit, the third warning signal output command for driving the signal outputting unit to output a third warning signal if the electronic device cannot read the parameters in the storage unit according to the BIOS program after the electronic device is turned on and runs for a period of time.

19. The method of claim 18, wherein the third warning signal is for indicating that electrical connection between the storage unit and a corresponding slot is not correct.

20. The method of claim 11, wherein the signal outputting unit is one of a loudspeaker unit and a display unit.
